(19) United States
(12) Patent Application Publication
(10) Pub. No.: US 2023/0358197 A1
(43) Pub. Date: Nov. 9, 2023

(54) NOZZLE SPRAY PATTERN FOR A FUEL INJECTOR

(71) Applicant: Cummins Inc., Columbus, IN (US)

(72) Inventors: Anthony A. Shaull, Columbus, IN (US); Florin Mocanu, Columbus, IN (US); Eric M. Osecky, Indianapolis, IN (US); Rajesh K. Garg, Novi, MI (US)

(21) Appl. No.: 18/307,537

(22) Filed: Apr. 26, 2023

Related U.S. Application Data
(63) Continuation of application No. PCT/US2021/057655, filed on Nov. 2, 2021.
(60) Provisional application No. 63/108,550, filed on Nov. 2, 2020.

(51) Int. Cl. F02M 61/18

(52) U.S. Cl. CPC F02M 61/1813

(57) ABSTRACT

A fuel injector nozzle comprising at least two sets of injector orifices, each set of injector orifices including a first injector orifice and a second injector orifice, wherein the first injector orifice is parallel to the second injector orifice, and each set of injector orifices is angled relative to at least one other set of injector orifices.

### RELATED APPLICATION

This application is a continuation of International PCT Application No. PCT/US2021/057655 filed on Nov. 2, 2021, which claims priority to U.S. Provisional Pat. Application No. 63/108,550 filed Nov. 2, 2020, the disclosure of each of which is incorporated herein by reference.

### STATEMENT REGARDING FEDERALLY SPONSORED RESEARCH OR DEVELOPMENT

This Project Agreement Holder (PAH) effort was sponsored by the U.S. Government under Other Transaction number W15QKN-14-9-1002 between the National Advanced Mobility Consortium and the Government. The U.S. Government is authorized to reproduce and distribute reprints for Governmental purposes notwithstanding any copyright notation thereon.

### TECHNICAL FIELD OF THE DISCLOSURE

The present disclosure relates to a fuel injector of an engine and, more particularly, to a nozzle spray pattern of the fuel injector.

### BACKGROUND OF THE DISCLOSURE

A two-stroke opposed piston engine utilizes two common rail fuel injectors per cylinder with an injector on either side of the cylinder. The high-power density of the engine requires high fuel quantities from the injectors which requires higher hydraulic flow from the injector nozzles. The spray patterns of the injector nozzles are clocked and the spray of one injector is “laced” with the spray of the injector from the other side of the engine or the sprays of the two injectors collide with one another. This architecture results in spray pattern angles which are much deeper than conventional four-stroke engines. However, the larger spray hole sizes have demonstrated less than optimal spray plume quality. Thus, a need exists for an improved injector nozzle with improved fuel flow to each spray hole of the injector nozzle and improved fuel spray quality for combustion.

### SUMMARY OF THE DISCLOSURE

In one aspect of the present disclosure, a fuel injector nozzle is provided comprising a plurality of injector orifices including at least a first injector orifice, a second injector orifice, and a third injector orifice, wherein the first injector orifice extends parallel to the second injector orifice, and the first and second injector orifices are angled relative to the third injector orifice

In another aspect of the present disclosure, a fuel injector nozzle is provided comprising at least two sets of injector orifices, each set of injector orifices including a first injector orifice and a second injector orifice, wherein the first injector orifice is parallel to the second injector orifice, and each set of injector orifices is angled relative to at least one other set of injector orifices.

In a further aspect of the present disclosure, a fuel injector nozzle is provided comprising a plurality of injector orifices including at least a first injector orifice, a second injector orifice, and a third injector orifice, wherein the first injector orifice has an inlet and an outlet, the second injector orifice has an inlet and an outlet, and the third injector orifice has an inlet and an outlet, the inlets of the first injector orifice, the second injector orifice, and the third injector orifice each being evenly spaced apart on a nozzle sac, the outlet of the first injector orifice and the outlet of the second injector orifice being spaced apart a first distance, and the outlet of the second injector orifice and the outlet of the third injector orifice being spaced apart a second distance, the second distance being greater than the first distance.

Advantages and features of the embodiments of this disclosure will become more apparent from the following detailed description of exemplary embodiments when viewed in conjunction with the accompanying drawings.

### BRIEF DESCRIPTION OF THE DRAWINGS

FIG. 1 shows a block diagram of an engine with cylinders according to aspects of the present disclosure;

FIG. 2 shows a schematic cross-sectional view of a cylinder of a two-stroke opposed piston engine;

FIG. 3 shows a schematic top down view of the cylinder of FIG. 2 showing spray plumes of fuel injectors of the present disclosure;

FIG. 4 shows a phantom view of a first embodiment of a nozzle of a fuel injector of the present disclosure showing injector orifices of the fuel injector;

FIG. 5 shows a perspective view of a nozzle sac of the fuel injector of FIG. 4;

FIG. 6 shows a perspective view of an exterior of the nozzle of FIG. 4;

FIG. 7 shows a perspective view of a nozzle sac of a second embodiment of a nozzle of a fuel injector of the present disclosure;

FIG. 8 shows a perspective view of an exterior of the nozzle of the fuel injector of FIG. 7;

FIG. 9 shows a graphical comparison of liquid penetration in meters versus crank angle in degrees of the present disclosure nozzle of FIG. 3 and a known nozzle;

FIG. 10 shows various graphics of spray plumes of the nozzle of FIG. 3; and

FIG. 11 shows various graphics of spray plumes of known nozzles.

### DETAILED DESCRIPTION OF THE DRAWINGS

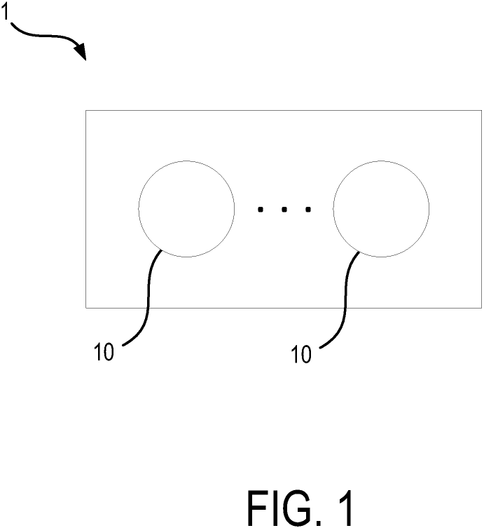

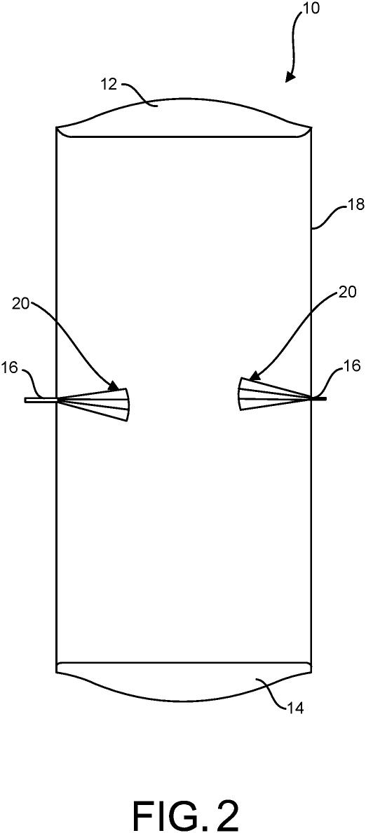

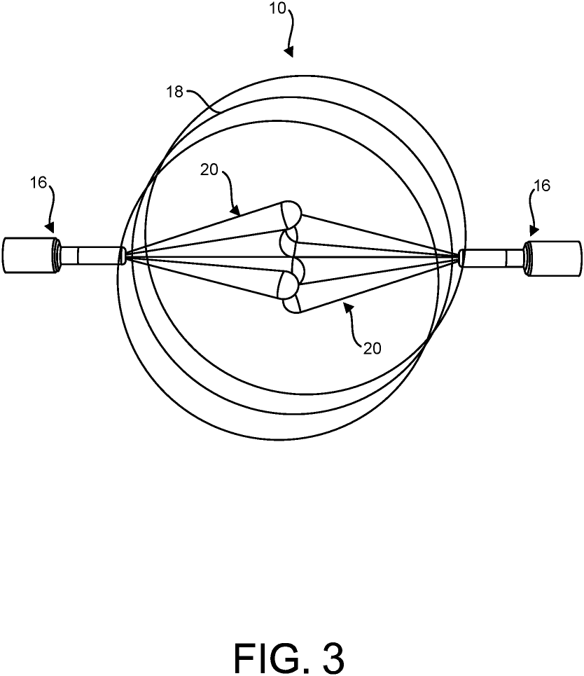

Referring to FIGS. 1-3, a cylinder 10 of a two-stroke opposed piston engine 1 (seen in FIG. 1) is shown. The engine 1 includes at least one cylinder 10 that has an intake piston 12 at a first end of cylinder 10, an exhaust piston 14 at a second end of cylinder 10 opposite the first end, and two fuel injectors 16 positioned across from one another along a wall 18 of cylinder 10. Fuel injectors 16 are configured to inject metered quantities of fuel into cylinder 10 in timed relation to the reciprocation of pistons 12 and 14, which create a combustion chamber when at their closest positions. Fuel injectors 16 are positioned such that spray plumes 20 from injectors 16 extend across cylinder 10 and interlace with one another, as shown in FIG. 3.

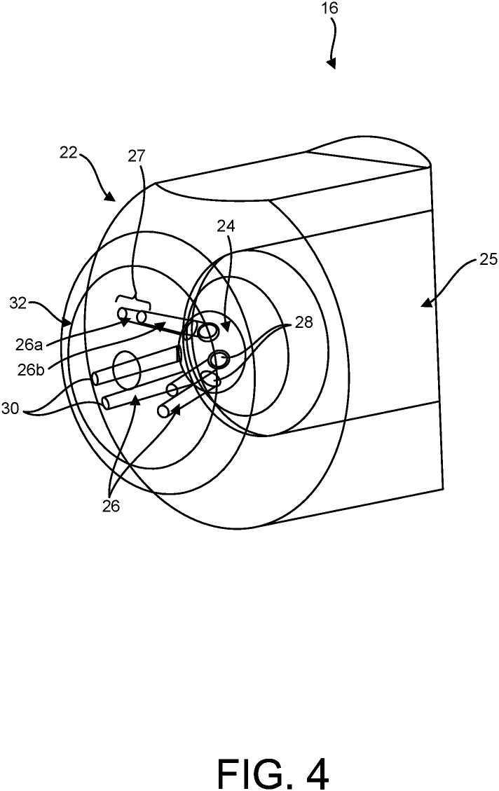

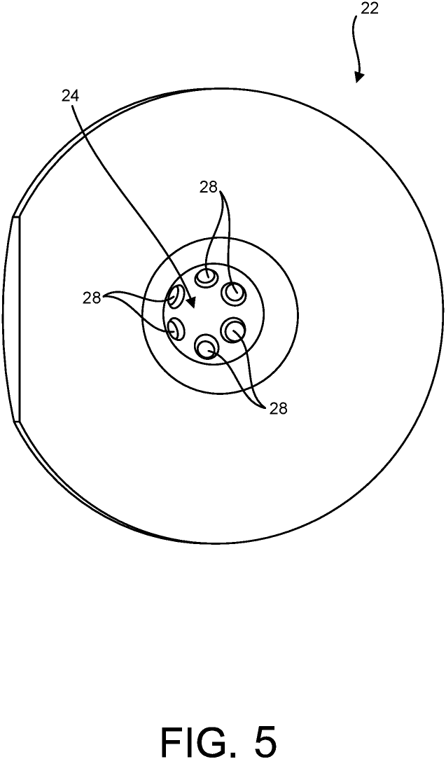

With reference to FIGS. 4-6, a first embodiment of fuel injectors 16 is shown. Fuel injectors 16 each include a nozzle 22 having a nozzle sac 24 (FIG. 5) and a plurality of injector orifices 26, illustratively six, extending from nozzle sac 24 to an exterior surface 32 of nozzle 22. Injector orifice(s) 26 communicate with one end of an injector cavity 25 of injector 16 to discharge fuel into cylinder 10 of the engine1. The injector orifice(s) 26 include inlets 28 and outlets 30. Inlets 28 of injector orifices 26 are positioned adjacent to and fluidly coupled to nozzle sac 24, while outlets 30 are positioned along exterior surface 32 of nozzle 22. Inlets 28 of injector orifices 26 are generally spaced evenly or substantially evenly apart within nozzle sac 24 such that orifices 26 get equal hole flow and smooth flow streamlines (FIG. 5).

Injector orifices 26 are provided in three sets 27 of two separate injector orifices 26a and 26b. The two separate injector orifices 26a and 26b of each set 27 are parallel to one another along their length and have the same angle trajectory, while each set 27 of injector orifices 26 is angled relative to the other sets 27 of injector orifices 26. As such, inlets 28 are positioned evenly or substantially evenly about nozzle sac 24, while outlets 30 of injector orifices 26a and 26b of set 27 are adjacent to one another and spaced apart by a first distance d₁, and outlets 30 of each different set 27 are spaced apart from outlets 30 of the other sets 27 by a second distance d₂, which is greater than first distance d₁. Though sets 27 include two separate orifices 26, the proximity of the two separate orifices 26 allow for a single spray plume 20 to be produced by each separate set 27.

In various embodiments, a diameter of inlets 28 of injector orifices 26 may be larger than a diameter of outlets 30 of injector orifices 26. The relationship between the diameters of inlets 28 and outlets 30 can be characterized as a K-factor, calculated as follows:

$$K - f a c t o r = 100 x \frac{i n l e t d i a m e t e r - o u t l e t d i a m e t e r}{l e n g t h o f o r i f i c e} .$$

The parallel distance between injector orifices 26a and 26b is defined by material stress limitations due to the high fluid pressure (+1800 bar) and manufacturing capabilities.

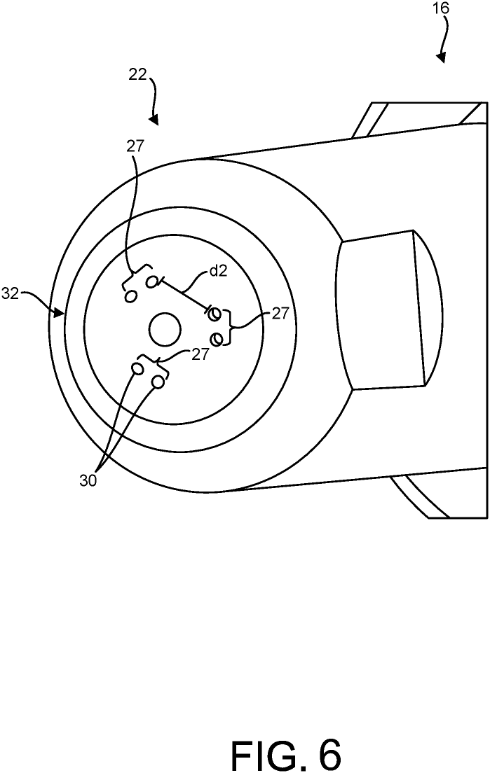

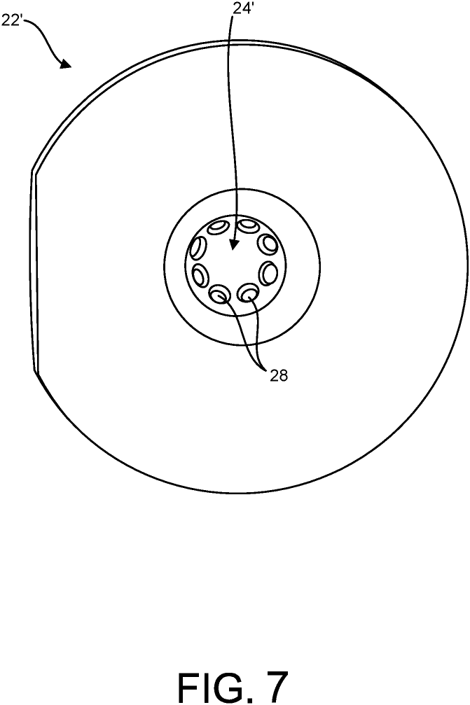

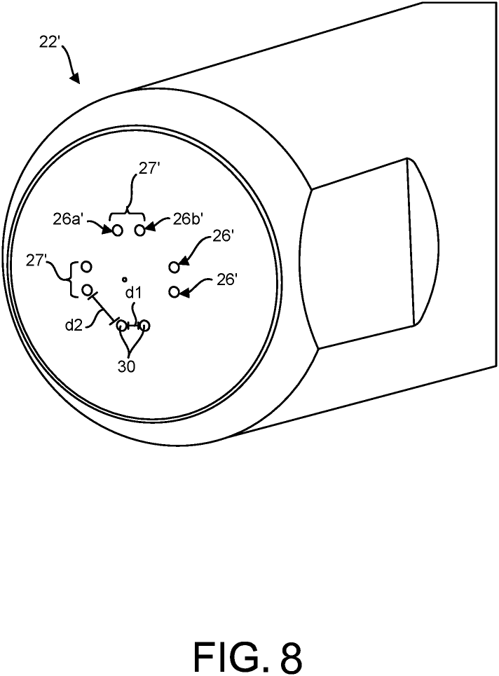

Referring to FIGS. 7 and 8, in various embodiments, nozzle 22 may include various sets 27 of injector orifices 26, for example three sets 27 of injectors orifices 26, as shown in FIGS. 5 and 6, or four sets 27 of injectors orifices 26, as shown in FIGS. 7 and 8. The second embodiment of nozzle 22′ still has inlets 28′ being positioned evenly or substantially evenly about nozzle sac 24′, while outlets 30′ of injector orifices 26a′ and 26b′ of set 27′ are adjacent to one another and spaced apart by a first distance d₁′, and outlets 30′ of each different set 27′ are spaced apart from outlets 30′ of the other sets 27′ by a second distance d₂′ greater than first distance d₁′. Second distance d₂′ is a function of an angle of set 27 relative to a centerline of injector 16, the number of sets 27, and the position of the sets 27 within nozzle sac 24.

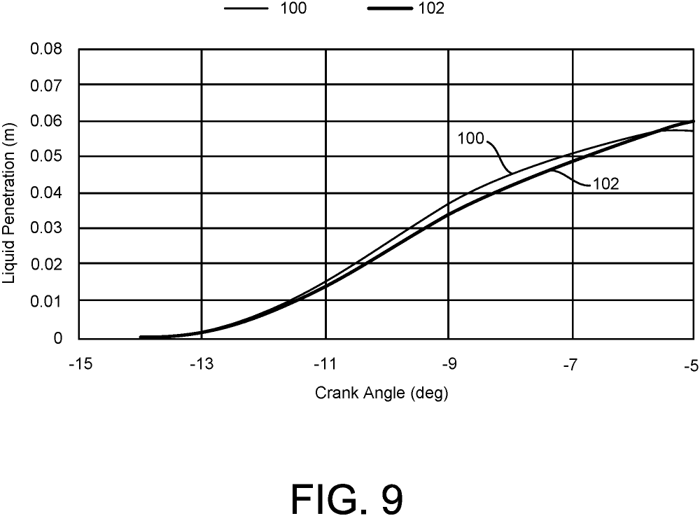

With reference to FIGS. 9-11, various possible improvements of nozzle 22 of the present disclosure relative to known nozzles are shown. These known nozzles typically include injector orifices that are all angled relative to one another. In the present disclosure, each injector orifice 26 is divided into a set 27 of two separate injector orifices 26a and 26b. The arrangement of injector orifices 26 of nozzle 22 of the present disclosure may allow for improved spray quality, improved flow, deeper spray plume length, improved plume to plume quality, and/or reduced plume variation as compared to the arrangement of injector orifices of known nozzles. For example, and as shown in FIG. 9, the liquid penetration of nozzle 22 of the present disclosure, shown as line 100, may be greater than the liquid penetration of known nozzles, shown as line 102, from a crank angle of approximately -11 degrees to -6 degrees.

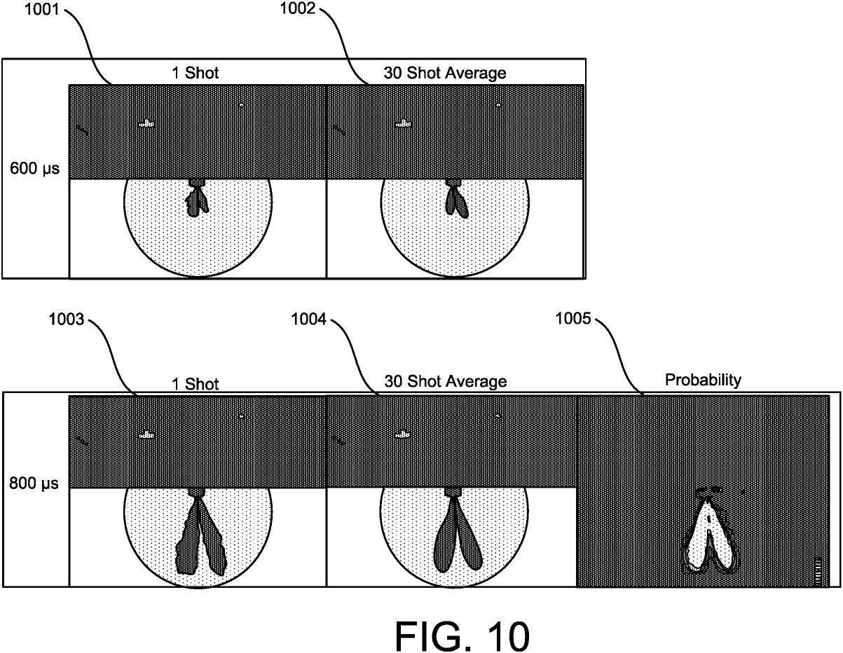

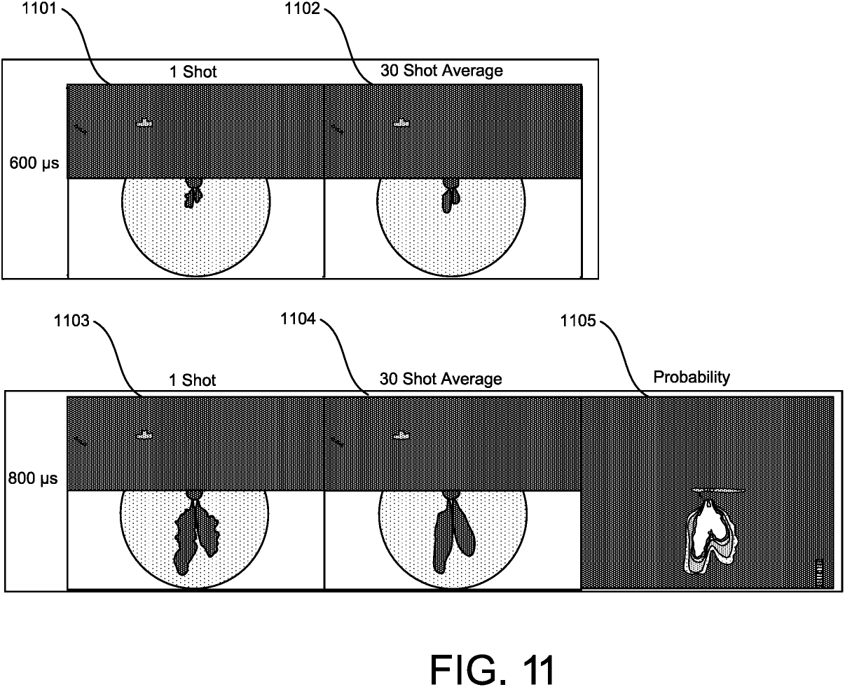

In addition, and with reference to FIGS. 10 and 11, when fuel is passed through nozzle 22 of injectors 16 of the present disclosure (FIG. 10) and a known nozzle (FIG. 11) into a spray chamber of nitrogen at 36 bar and 25° C. at a flow rate of 300 pounds per hour, where the K-factor of orifices of the presently disclosed nozzle 26 and a known nozzle is 2 and the fuel is injected at a pressure of 1800 bar for 1 millisecond, the plume variation of nozzle 22 of the present disclosure is reduced as compared to a known nozzle.

Specifically, with reference to FIG. 10, graphic 1001 shows an image of spray plumes of the presently disclosed nozzle 22 after 600 microseconds of on time. Graphic 1002 shows an image of a single photo of spray plumes of the presently disclosed nozzle 22 after 800 microseconds of on time. Graphic 1003 shows an image of an average of 30 photos of spray plumes of the presently disclosed nozzle 22 after 600 microseconds of on time. Graphic 1004 shows an image of an average of 30 photos of spray plumes of the presently disclosed nozzle 22 after 800 microseconds of on time. Graphic 1005 shows a graphical display of probabilities the spray plumes of the presently disclosed nozzle 22 will reach the various areas.

Specifically, with reference to FIG. 11, graphic 1101 shows an image of spray plumes of the known nozzle after 600 microseconds of on time. Graphic 1102 shows an image of a single photo of spray plumes of the known nozzle after 800 microseconds of on time. Graphic 1103 shows an image of an average of 30 photos of spray plumes of the known nozzle after 600 microseconds of on time. Graphic 1104 shows an image of an average of 30 photos of spray plumes of the known nozzle after 800 microseconds of on time. Graphic 1105 shows a graphical display of probabilities the spray plumes of the known nozzle will reach the various areas after 800 microseconds of on time.

As can be seen in graphic 1004 and 1104 in FIGS. 10 and 11 respectively, nozzle 22 of the present disclosure also may provide a deeper spray plume length, reduced plume variation, more equal spray plumes, and/or narrower spray plume cone angles as compared to the known nozzle.

Furthermore, and as shown below in Table 1, nozzles of the present disclosure also may allow for improved power, indicated thermal efficiency (ITE), and heat losses per power ratio, and/or reduced soot as compared to the known nozzle. Each of the various improvements discussed herein may allow for better combustion within the combustion chamber of cylinders of the engine, and therefore improved power and/or efficiency of the engine.

TABLE 1

Various Comparisons between a Known Nozzle and the Presently Disclosed Nozzle

| | CC Power (kW) | ITE (%) | Heat Losses/CC Power (kW) | Soot (g/kg) |
|---|---|---|---|---|
| Single 3-hole known nozzle | 192.7 | 41.7 | 22.2 | 0.73 |
| Dual 3-hole | 194.5 | 42.1 | 22.9 | 0.56 |

While various embodiments of the disclosure have been shown and described, it is understood that these embodiments are not limited thereto. The embodiments may be changed, modified, and further applied by those skilled in the art. For instance, the present disclosure may further be applied to fuel injectors in other various types of combustion engines. Therefore, these embodiments are not limited to the detail shown and described previously, but also include all such changes and modifications.

What is claimed is:

1-20. (canceled)

21. A fuel injector nozzle, comprising:
a plurality of injector orifices including at least a first injector orifice and a second injector orifice, wherein the first injector orifice extends parallel to the second injector orifice, and the first and second injector orifices are optionally angled relative to a third injector orifice in the plurality of injector orifices.

22. The fuel injector nozzle of claim 21, further including a nozzle sac, wherein each of the plurality of injector orifices extends from the nozzle sac to an exterior surface of the fuel injector nozzle.

23. The fuel injector nozzle of claim 21, wherein each injector orifice has an inlet having a first diameter and an outlet having a second diameter, the first diameter being larger than the second diameter.

24. The fuel injector nozzle of claim 21, wherein the plurality of injector orifices includes the third injector orifice, and wherein the first injector orifice has an inlet and an outlet, the second injector orifice has an inlet and an outlet, and the third injector orifice has an inlet and an outlet, the inlets of the first injector orifice and the second injector orifice, and the inlets of the second injector orifice and the third injector orifice each being spaced apart evenly on a nozzle sac, the outlet of the first injector orifice and the outlet of the second injector orifice being spaced apart a first distance, and the outlet of the second injector orifice and the outlet of the third injector orifice being spaced apart by a second distance, the second distance being greater than the first distance.

25. The fuel injector nozzle of claim 24, wherein the plurality of injector orifices further includes a fourth injector orifice, an inlet of the fourth injector orifice evenly spaced apart from the inlet of the third injector orifice, the inlet of the second injector orifice, and inlet of the first injector orifice, and an outlet of the fourth injector orifice spaced apart from the outlet of the third injector orifice by the first distance.

26. The fuel injector nozzle of claim 25, wherein the first injector orifice and the second injector orifice are angled relative to the third injector orifice and the fourth injector orifice.

27. The fuel injector nozzle of claim 21, wherein the first and second injector orifices are angled relative to the third injector orifice.

28. The fuel injector nozzle of claim 21, wherein the plurality of injector orifices includes two sets of injector orifices, a first set of injector orifices including the first and second injector orifices and each additional set of injector orifices including a first and second set of injector orifice thereof, and wherein for each of the sets of injector orifices, the first injector orifice is parallel to the second injector orifice, and each of the sets of injector orifices is angled relative to at least one other set of injector orifices.

29. A fuel injector nozzle, comprising:
at least two sets of injector orifices, each set of injector orifices including a first injector orifice and a second injector orifice, wherein the first injector orifice is parallel to the second injector orifice, and each set of injector orifices is angled relative to at least one other set of injector orifices.

30. The fuel injector nozzle of claim 29, wherein the at least two sets of injector orifices includes four sets of injector orifices.

31. The fuel injector nozzle of claim 30,
wherein each set of injector orifices further includes a third injector orifice,
wherein each of the first injector orifices has an inlet and an outlet, each of the second injector orifices has an inlet and an outlet, and each of the third injector orifices has an inlet and an outlet,
the inlets of the first injector orifice, the inlet of the second injector orifice, and the inlet of the third injector orifice each being spaced apart evenly on a nozzle sac,
the outlets of each of the first injector orifices and the second injector orifices being spaced apart within the respective set of fuel injector orifices by a first distance, and the outlets of each of the second injector orifices and the third injector orifices being spaced apart within the respective set of fuel injector orifices by a second distance, the second distance being greater than the first distance.

32. The fuel injector nozzle of claim 31, wherein each set of injector orifices further includes a fourth injector orifice,
inlets of each of the fourth injector orifices evenly spaced on the nozzle sac apart from the inlets of each of the third injector orifices, the second injector orifices, and the first injector orifice, and
outlets of each of the fourth injector orifices spaced apart from the outlets of each of the third injector orifice within the respective set of fuel injector orifices by the first distance, and
wherein each of the first injector orifices and the second injector orifices within the respective set of fuel injector orifices are angled relative to each of the third injector orifices and each of the fourth injector orifices.

33. A fuel injector nozzle, comprising:
a plurality of injector orifices including:
at least a first injector orifice,
a second injector orifice, and
a third injector orifice,
wherein the first injector orifice has an inlet and an outlet, the second injector orifice has an inlet and an outlet, and the third injector orifice has an inlet and an outlet,
the inlets of the first injector orifice, the second injector orifice, and the third injector orifice each being evenly spaced apart on a nozzle sac,
the outlet of the first injector orifice and the outlet of the second injector orifice being spaced apart a first distance, and the outlet of the second injector orifice and the outlet of the third injector orifice being spaced apart a second distance, the second distance being greater than the first distance.

34. The fuel injector nozzle of claim 33, wherein the plurality of injector orifices further includes a fourth injector orifice, an inlet of the fourth injector orifice evenly spaced apart on the nozzle sac from the inlets of the third injector orifice, the second injector orifice, and the first injector orifice, and an outlet of the fourth injector orifice spaced apart from the outlet of the third injector orifice by the first distance.

35. The fuel injector nozzle of claim 34, wherein the first injector orifice and the second injector orifice are angled relative to the third injector orifice and the fourth injector orifice.

36. The fuel injector nozzle of claim 33, wherein each injector orifice has an inlet and an outlet, and each of the inlets are spaced a first distance apart and each of the outlets are spaced apart by a second distance, the second distance between equal to or greater than the first distance.

37. The fuel injector nozzle of claim 33, wherein the plurality of injector orifices includes three sets of injector orifices.

38. The fuel injector nozzle of claim 33, wherein the plurality of injector orifices are positioned along a wall of a cylinder of an engine.

39. The fuel injector nozzle of claim 38, wherein engine is a two-stroke opposed piston engine.

40. The fuel injector nozzle of claim 39, wherein the cylinder has an intake piston at a first end of the cylinder, an exhaust piston at a second end of the cylinder opposite the first end, and further comprising two fuel injectors positioned across from one another along the wall of the cylinder, and wherein the fuel injector nozzle includes at least two fuel injector nozzles such at each of the two fuel injectors comprises a respective one of the fuel injector nozzles.
